(19) United States
(12) Patent Application Publication
(10) Pub. No.: US 2001/0005347 A1
(43) Pub. Date: Jun. 28, 2001

(54) CD cleaning and labeling device

(76) Inventor: Yun-Ming Kwang, Taipei (TW)

Correspondence Address: DOUGHERTY & TROXELL, SUITE 1404, 5205 LEESBURG PIKE, FALLS CHURCH, VA, 22041, US

(21) Appl. No.: 09/756,655

(22) Filed: Jan. 10, 2001

Related U.S. Application Data
(63) Continuation-in-part of application No. 09/328,381, filed on Jun. 9, 1999.

(51) Int. Cl. G11B 3/58

(52) U.S. Cl. 369/72

(57) ABSTRACT

A CD cleaning and labeling device includes a basin-shaped upper case, a lower case engageable with the upper case, a base having a concave base center located inside the lower case for providing a CD supporting surface, and a movable sticking seat located inside the base center. The upper case is furnished with at least one CD cleaning means. The lower case has a base for carrying a CD or a CD label. The sticking seat has a brim for allowing a CD label with a center hole to be sleeved along and a top surface for resting the CD. The sticking seat is movable between an extension position and a retracting position. While in the retracting position, the top surface of the sticking seat is lower than the supporting surface of the base so as to allow the CD to rest upon the supporting surface of the base. While in the extension position, the top surface is higher than the supporting surface so that the CD rests on the top surface by a predetermined space from the supporting surface, and in the mean time, the CD label can be positioned upon the supporting surface of the base.

This application is a Continuation-in-Part Application of U.S. patent application Ser. No. 09/328,381, entitled “A CD CLEANING AND LABELING DEVICE”, filed on Jun. 9, 1999, now pending.

### BACKGROUND OF THE INVENTION

### DESCRIPTION OF THE PRIOR ART

Generally, after leaving a production line or after recorded, a CD should be labeled for indicating contents, records, advertisement or other purposes. Also, a CD-R or CD after being used for a period of time should be cleaned to wipe up any contamination on the recording surface so that high reading quality can be maintained. Conventional method of cleaning CD usually includes brushing or sweeping CD surface manually. There is also a CD cleaning kit in the market that includes a case for containing a CD and an actuating means to rotate a cleaning pad for brushing over the CD surface.

On the other hand, one label-applying device is developed uniquely for CD labeling. Usually, the label for a CD is an annular sticker to fit one side of the CD. The side of the CD for sticking the label is defined as a label-sticking surface, and the opposing side of the same CD is defined as a recording surface. While in CD labeling, the label-sticking surface is faced down for being pressed onto a lower label.

Referring to FIG. 1, a conventional labeling device 1 is shown, in which the device is developed uniquely for CD labeling. Usually, the label for a CD is an annular sticker to fit one side of the CD. The side of the CD for sticking the label is defined as a label-sticking surface, and the opposing side of the same CD is defined as a recording surface. As shown, a CD 5 for adhering a label 6 is rest upon a top of a carrier block 2 having a central extended handle 3. The label 6 is put on a platform 4 with its label-sticking surface upwards. While in CD labeling, the handle 3 as well as the carrier block 2 are depressed downwards to the platform 4 and to have the CD 5 stuck to the label-sticking surface of the label 6. However, the conventional labeling device 1 includes an extended handle 3, so its portability is limited.

Conventionally, CD cleaning and CD labeling need different means to perform; i.e., using one device for cleaning the CD and another device for labeling the CD. Obviously, that a CD needs two devices for maintenance is costly and wastes service time.

Other prior arts including cleaning devices disclosed in U.S. Pat. No. 5,963,526, No. 5,822,822, No. 5,584,089, No. 4,825,497, No. 4,750,231, No. 4,709,437, No. 4,662,025, No. 4,520,470, and No. 4,654,917, and CD protective film applicator disclosed in U.S. Pat. No. 5,912,875, and CD cleaning apparatus of U.S. Pat. No. 5,307,535 are studied. However, none of the aforementioned prior arts has disclosed a single device which can perform both CD cleaning and CD labeling functions, nor any of them has disclosed a CD cleaning device having an openable auxiliary compartment for storing additional cleaning materials.

### SUMMARY OF THE INVENTION

In view of aforesaid disadvantages, it is therefore an object of this invention to provide a CD cleaning and labeling device that can perform CD cleaning, CD labeling and CD storage in a unique apparatus for reducing cost and production time.

The CD cleaning and labeling device according to this invention includes an upper case pivotally engaged with a lower case for forming a closed container to house a CD therein. The upper case has a driving means engageable with at least a cleaning means. The lower case has a base for holding the CD, a driven means engageable with the driving means and the base, and a sticking seat movable up or down along a center line of the base for lifting or lowering the CD corresponding to an extension position or an retracting position.

When in use for cleaning, the upper case may engage with the lower case, the driving means may engage with the driven means, the sticking seat is in the retracting position, and the cleaning means presses a CD located upon the base with a face-up recording surface. Driven by the actuating means, the driven means as well as the base rotate accordingly, and thereby the CD on the base can be brushed over by the cleaning means.

When in use for labeling, the upper case is opened and the sticking seat is arranged at the extension state first, then place a label on the base with a gluing surface facing up, and dispose a CD on the sticking seat with the label-sticking surface facing down. By closing the upper case to engage with the lower case, the sticking seat and the CD will be lowered by the upper case and move downward to make contact with the gluing surface of the label. Then, the label can be well adhered to the CD after the upper case and the lower case is closed completely. Further, by turning the driving means, the cleaning means can run over the whole CD surface to ensure the label firmly and smoothly adhered to the CD.

According to one aspect of this invention, the upper case is pivotally engaged with the lower case by means of a spindle or the like. At least one cleaning means are provided for giving substantial pressure upon the CD. The cleaning means may be driven by the driving means through a gear set located in between. The base may be supported by an elastic means to get sufficient spring force against the depression from the upper case, and thereby the tight contact between the CD and the cleaning means while closing the upper and the lower cases can be confirmed. The driven means and the sticking seat are located in a center recess of the base. Below the lower case, an auxiliary compartment may be provided for holding other auxiliary materials such as a cleaning CD for cleaning an optical pick-up.

In one embodiment of the present invention, for avoiding any location biasing of a CD rest upon the sticking seat, it can include a bumpy CD anchoring portion at the top thereof for providing a interior stop with respect to a central hole of the CD.

In one embodiment of the present invention, the cleaning means can be a separable element with a cleaning surface that can be stored in the upper case and can be removed by hand for brush upon a CD.

In one embodiment of the present invention, the CD cleaning device can include an auxiliary compartment located below the lower case, which the compartment may be provided for holding other auxiliary materials such as a cleaning CD for cleaning an optical pick-up.

### BRIEF DESCRIPTION OF THE DRAWINGS

The invention, as well as its many advantages, may be further understood by the following detailed description and drawings in which:

FIG. 1 is a side view of a conventional labeling device;

FIG. 2 is a perspective exploded view of a first embodiment of the CD cleaning and labeling device in accordance with the present invention;

FIG. 3 is a sectional view of the CD cleaning device of FIG. 2 with the upper case closed upon the lower case, showing a cleaning operation;

FIG. 4A is a sectional view of the CD cleaning device of FIG. 2 with the upper case opened, showing a labeling operation;

FIG. 4B is a sectional view of the CD cleaning device of FIG. 2 with the upper case half opened, showing a labeling operation;

FIG. 4C is a sectional view of the CD cleaning device of FIG. 2 with the upper case closed, showing a labeling operation;

FIG. 5 is a perspective exploded view of a second embodiment of the CD cleaning and labeling device in accordance with the present invention;

FIG. 6 is a perspective exploded view of a third embodiment of the CD cleaning and labeling device in accordance with the present invention;

FIG. 7 is a perspective exploded view of a fourth embodiment of the CD cleaning and labeling device in accordance with the present invention; and

FIG. 8 is a perspective exploded view of a CD labeling device in accordance with the present invention.

### DETAILED DESCRIPTION OF THE PREFERRED EMBODIMENT

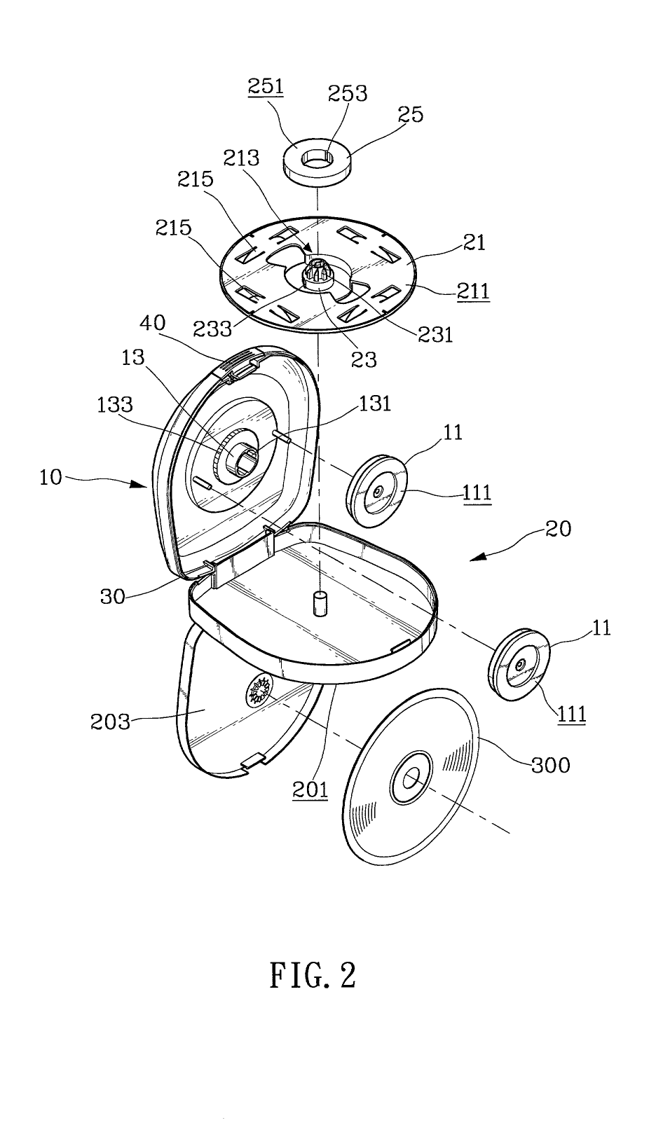

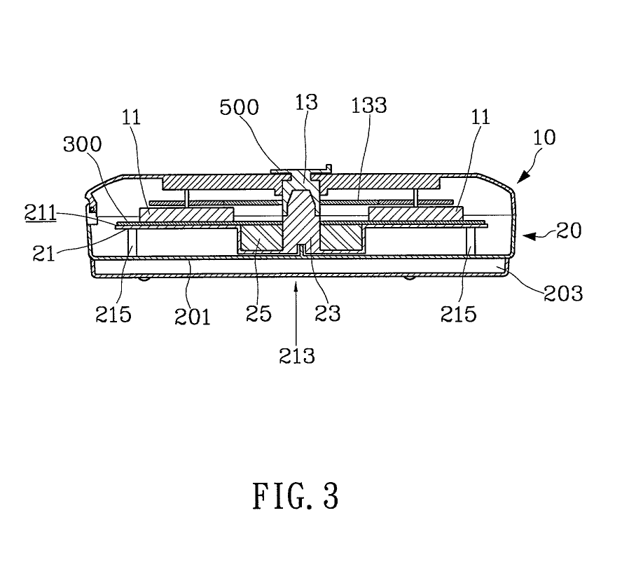

Referring now to FIGS. 2 and 3, the CD cleaning and labeling device according to this invention includes an upper case 10 pivotally engageable with a lower case 20 by means of a pivotal means 30 located at one side and may be latched at another side by means of a latching means 40 to form a closed compartment for housing a CD or a CD label therein. The pivotal means 30 and the latching means 40 may be substituted by other similar means known in the art.

The upper case 10 is formed in a convex basin shape and has a center opening to engage with an actuating means 500 (see FIG. 3) located outside the upper case 10. Within the upper case 10, there is a driving means 13 engageable with the actuating means 500 and at least one cleaning means 11. The driving means 13 includes a hollow tube 131 that has a inner gear-shaped interior and attaches a main gear 133 around the hollow tube. The gear-shaped interior may be substituted by other engaging means known in the art.

The cleaning means 11 is a disk-shaped wheel which has a flat surface 111 attached either fully or partly with a CD cleaning medium such as fluff, cloth, brush or the like. The cleaning means 11 may further be pivotally supported by a spindle and may attach a gear to engage with the main gear 133. FIG. 2 shows an embodiment that has two cleaning means 11 apart from each other at 180 degree to get even pressure on the CD surface during cleaning operation.

The actuating means 500 as shown in FIG. 3 may be any manual rotating means known in the art, such as a crank shaft, a wheel, a counter sunk head screw or the like.

The lower case 20 is formed in a concave basin shape but with a flat bottom and a top opening to mate and engage with the upper case 10. In the lower case 20, there are a disk-shaped base 21 which has a supporting surface 211 for carrying a CD thereon, a base center 213 for aligning with the CD center, a plurality of elastic members 215 located thereunder; a driven means 23 located above the base center 213 and having an engaging shaft 231 for engaging with the hollow tube 131 and a plurality of bulges 233 formed on the outside circumference; and an annular sticking seat 25 located in the base center 213. The sticking seat 25 further has a plurality of keyways 253 in the inside circumference for engaging with the respective bulges 233. Thus, the sticking seat 25 may move up to the extension position or move down to the retracting position and engages with the driven means 23 at both positions. Under the sticking seat 25, there may be provided with elastic members (not shown in the figures) for lifting the sticking seat 25 upward at the extension position to make the top surface 251 of the sticking seat 25 above the supporting surface 211. However, when the sticking seat 25 is being pressed downward at the retracting position, its top surface 251 will be no higher than the supporting surface 211. The outer diameter of the sticking seat 25 is larger than the center opening of the CD but is smaller than the center opening of the CD label.

In the present invention, the keyways 253 and the engaged bulges 233 form a sliding means for allowing the sticking seat 25 to move along the driven means 23 within a predetermined stroke. The sliding means is well known in the art and can also be embodied as a bulge-and-keyway mechanism, a track-and-sliding block mechanism, or any like mechanism that permits the sliding between the sticking seat 25 and the driven means 23 within a predetermined stroke.

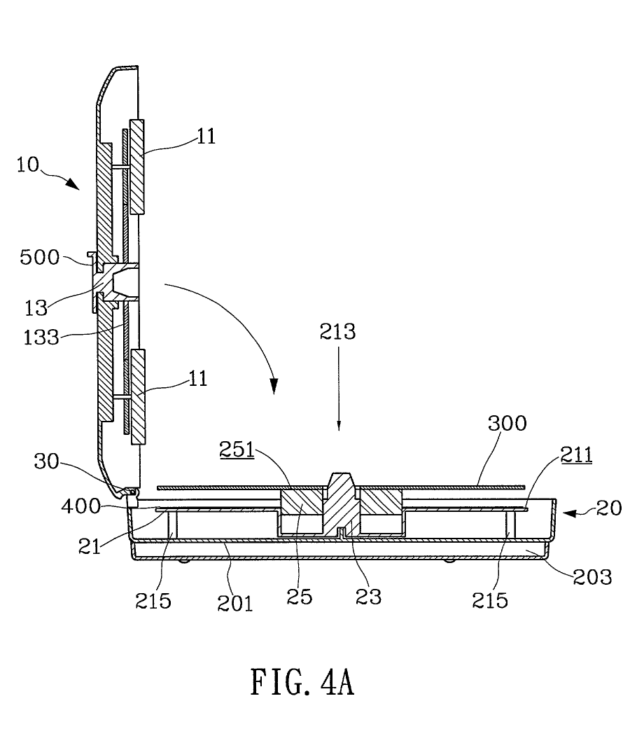

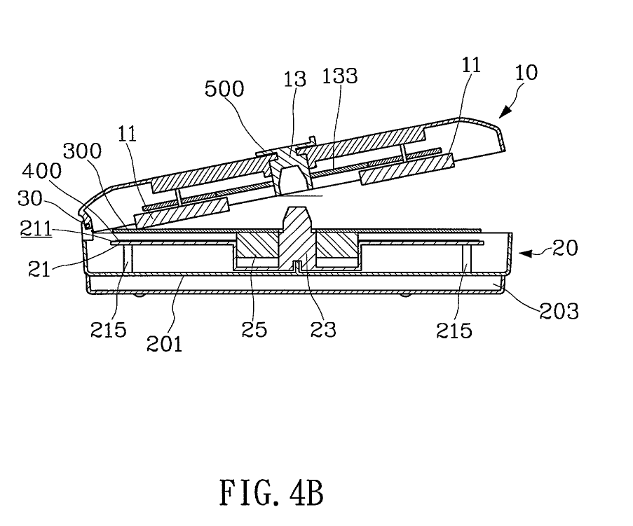

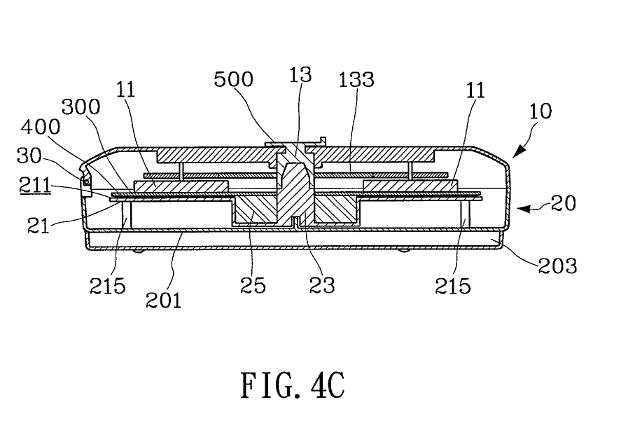

FIG. 3 shows this invention in use for CD cleaning. A CD 300 is placed on the base 21 firstly with a face-up recording surface, with the sticking seat 25 posing the retracting position (as the position shown in FIG. 4A). The upper case 10 is then moved to engage with the lower case 20. After closing the upper case 10 onto the lower case 20, the cleaning means 11 will make forced contact with the CD recording surface. Turning the actuating means 500 to rotate the driving means 13 which in turn drives the cleaning means 11 to rotate, the CD cleaning surface 111 (see FIG. 2) will sweep or brush the CD recording surface to remove dusts or dirties that might be harmful to CD reading quality.

FIGS. 4A, 4B and 4C illustrate this invention in use for a CD labeling operation. Before the labeling operation, the sticking seat 25 needs to be lifted upward at the extension position (as the position shown in FIG. 4A). The upper case 10 is open (FIG. 4A) for placing a CD label 400 on the supporting surface 211 with the gluing surface of the label 400 facing up. Then, placing the CD 300 on the top surface 251 of the sticking seat 25 with the label-sticking surface facing down. By closing the upper case 10, the cleaning means 11 and the front end of the hollow tube of the driving means 13 will press the CD 300 and push the sticking seat 25 downward to the retracting position so that the CD label-sticking surface will make contact with the gluing surface of the label 400. Then, the label 400 can be firmly adhered to the CD 300 by rotating the driving means 13 which turns the supporting surface 211 and the CD 300 and the label 400. Thereby, the label 400 will adhere to the CD 300 securely with the aid of the pressure from the cleaning means 11 and the elastic members 215.

As shown in FIG. 2, an openable auxiliary compartment 203 may be provided below the bottom of the lower case 20 for storing CD cleaning material such as small brush, screw driver, cleaning agent, cleaning CD or the like. The auxiliary compartment 203 may engage with the lower case 20 by means of latching means known in the art such as snap lock, screw, latch, lever or the like.

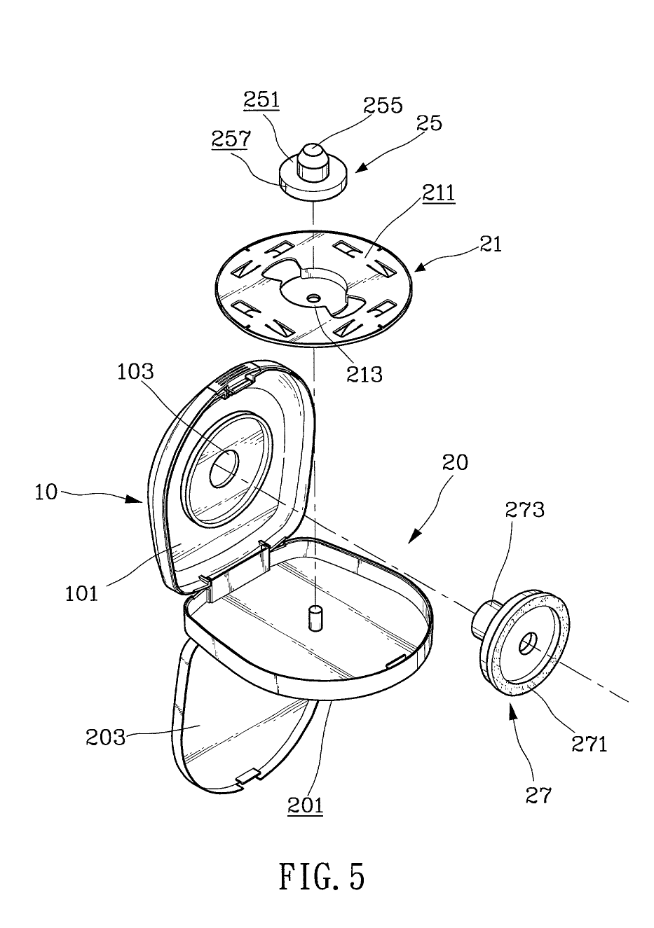

Referring now to FIG. 5, a second embodiment of the CD cleaning and labeling device is shown. In the second embodiment, a handy cleaning block 27 and a different sticking seat 25 are used to replace the cleaning means 11 and the sticking seat 25 of the aforesaid first embodiment shown in FIG. 2.

In the second embodiment as shown in FIG. 5, the cleaning block 27 having a bottom cleaning surface 271 is removably mounted under the upper case 10. The cleaning block 27 includes an extrusive top stem 273 for easing hand operation. Due to the disappearance of the cleaning means in the second embodiment, the aforesaid driven means 23 of FIG. 2 is also removed.

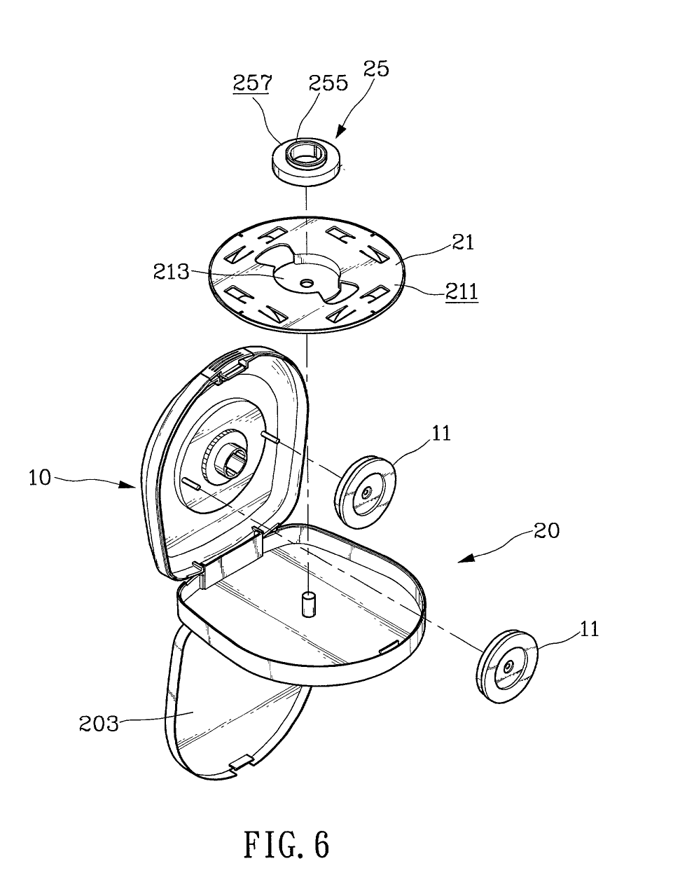

The sticking seat 25 of the second embodiment is also movable along the base center 213, and has a brim 257 substantially allowing a CD label with a center hole to be sleeved along. The sticking seat 25 also has a top surface 251 having a bumpy CD anchoring portion 255 sizable to plug into a center hole of a CD and thus rest the CD on the top surface 251 for avoiding any possible position bias of the CD on the supporting surface 211. According to the present invention, the CD anchoring portion 255 located upon the top surface 251 of the sticking seat 25 can be a disk, a ring (as shown in FIG. 6), a short pillar as shown in FIG. 5, or any extrusive body as the like.

In the present invention, the mechanism for sliding the sticking seat 25 along the base center 213 of the base 21 can be key-and-keyway pairs located therebetween, rack-and-groove pairs, or any the like.

Referring now to FIG. 6, a third embodiment of the CD cleaning and labeling device in accordance with the present invention is shown. In the third embodiment, a unique aforesaid cleaning means 11 of FIG. 2 as well as the respective driving means is re-applied and the CD anchoring portion 255 of the sticking seat 25 is embodied as a bumpy ring.

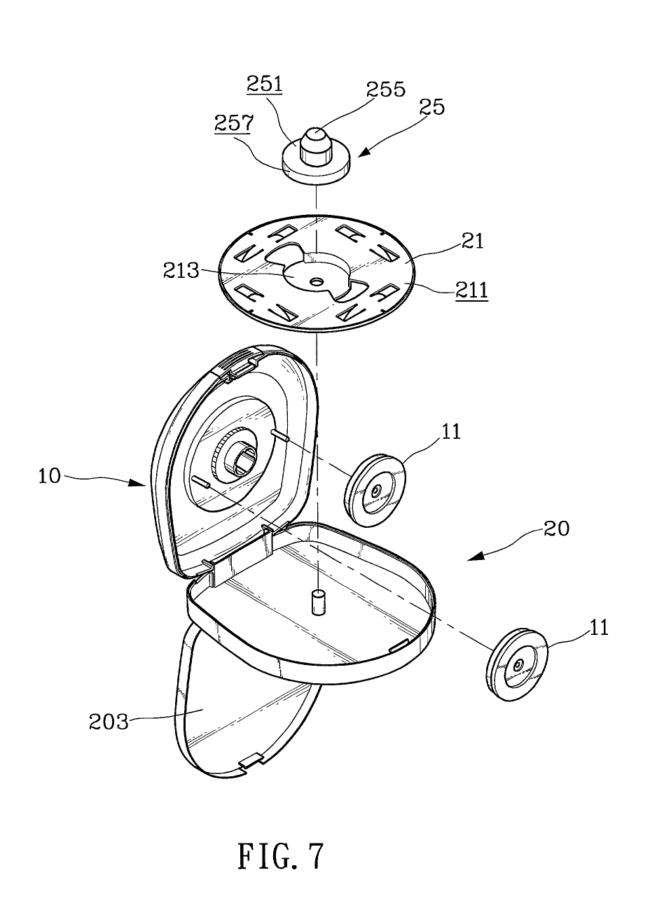

In the present invention, the sticking seat 25 can be embodied as the object in FIG. 2, in FIG. 5, in FIG. 6, or the like; and the CD cleaning tool can be embodied as the cleaning means 11 in FIG. 2, the cleaning block 27 in FIG. 5, or any the like. The arrangement of the sticking seat 25 and the cleaning tool can be carried out as the disclosure of FIG. 2, that of FIG. 5, that of FIG. 6, or the like combination such as a combination having the sticking seat 25 of FIG. 5 and the cleaning tool of FIG. 2 or FIG. 6, that having sticking seat 25 of FIG. 6 and the cleaning block 27 of FIG. 5, and the like. As shown in FIG. 7, a fourth embodiment of the present invention is an improvement of the third embodiment of FIG. 6 by utilizing the sticking seat 25 of the second embodiment of FIG. 5.

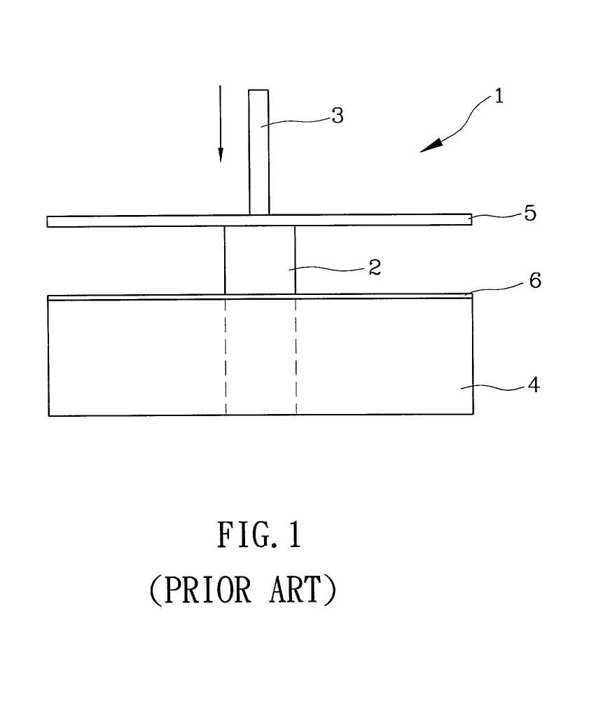

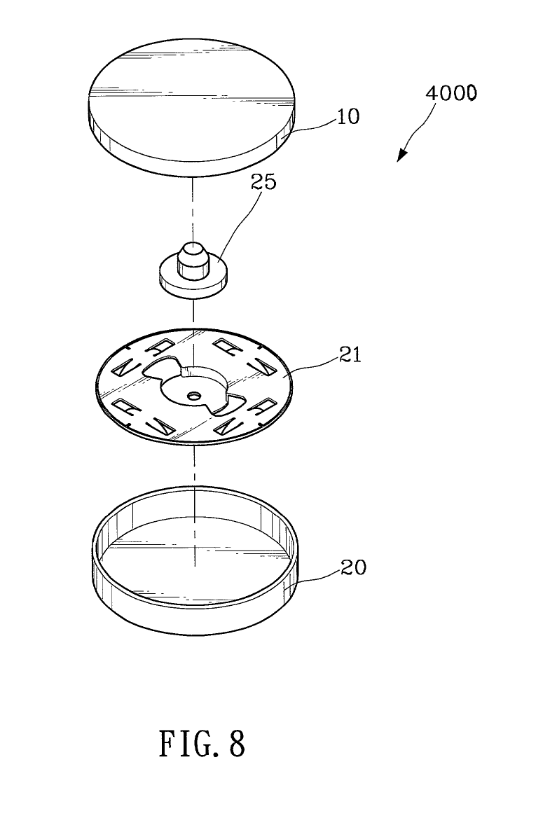

Referring now to FIG. 8, a simple-structured embodiment of a CD labeling device 4000 is explodedly shown. In the embodiment, the upper case 10 can be fully removed from the lower case 20, and the design of the cleaning block or the cleaning means is removed. In the lower case 20 of the embodiment, a base 21 and a sticking seat 25, both as previously described, are included. Due to a simplified structure, the CD labeling device 4000 can have better portability over the conventional labeling device shown in FIG. 1.

It is noted that, although many prior arts such as U.S. Pat. No. 5,963,526, No. 5,822,822, No. 5,584,089, No. 4,825,497, No. 4,750,231, No. 4,709,437, No. 4,662,025, No. 4,520,470, No. 4,654,917, No. 5,307,535, and No. 5,912,875 are refer to CD related devices. However, none of the prior arts has disclosed a single device which can perform both CD cleaning and CD labeling functions. None of these prior arts has been disclosed, taught, nor suggested a single CD cleaning device which includes an openable auxiliary compartment furnished below the lower case of the CD cleaning device for storing additional cleaning materials, such as cleaning liquid bottle, cleaning disc for CD player or the like. It is noted that, when performing CD cleaning operation by using any kind of CD cleaning devices, cleaning liquid (for example, alcohol) is usually applied on the CD for assisting cleaning result. However, since all of the prior art CD cleaning devices lack suitable compartment to store the cleaning liquid, users have to keep and carry the cleaning liquid separately. It is very inconvenient for users. The present invention discloses a CD cleaning device which has a build-in compartment for storing additional cleaning materials can effectively solve this problem.

It may thus be seen that the object of the present invention set forth herein, as well as those made apparent from the foregoing description, are efficiently attained. While the preferred embodiments of the invention have been set forth for purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed:

1. A CD cleaning device, comprising;
a case having an interior compartment;
a base with a concave base center, located inside the compartment for providing thereon a CD supporting surface;
at least one cleaning means having a bottom cleaning surface for cleaning a CD supported upon the supporting surface, said cleaning means being mounted in the case; and
a movable sticking seat located inside the base center, the sticking seat having a brim thereof for allowing a CD label with a center hole to be sleeved therealong and a top surface thereof for resting the CD; wherein the sticking seat is movable at least between an extension position and a retracting position; while in the retracting position, the top surface of the sticking seat is no higher than the supporting surface of the base; and while in the extension position, the top surface is higher than the supporting surface so that the CD rests on the top surface by a predetermined distance from the supporting surface.

2. The CD cleaning device of claim 1, wherein the case further includes a basin-shaped upper case having a recess and a lower case engageable with the upper case, wherein the base is located in the lower case.

3. The CD cleaning device of claim 2, wherein said sticking seat includes thereof a bumpy anchoring portion located on said top surface.

4. The CD cleaning device of claim 3, wherein said anchoring portion is choosing from a group consisting of a ring body and a short pillar body.

5. The CD cleaning device of claim 2 further includes a resilient member located between said sticking seat and said base center.

6. The CD cleaning device of claim 1, wherein said cleaning means is a cleaning block detachably mounted inside said case.

7. The CD cleaning device of claim 2 further includes a driving unit rotationally mounted inside said upper case for driving said cleaning means rotationally mounted inside said upper case, the driving unit for driving the cleaning means further including a shaft to penetrate through said upper case.

8. The CD cleaning device of claim 2 further includes an openable auxiliary compartment below the lower case for storing cleaning materials.

9. The CD cleaning device of claim 1, wherein said base further includes an elastic means located thereunder for providing spring force against depression thereon.

10. A CD labeling device, comprising;
a basin-shaped upper case;
a lower case engageable with the upper case;
a base with a concave base center, located inside the lower case for providing thereon a CD supporting surface; and
a movable sticking seat, located inside the base center, having a brim thereof for allowing a CD label with a center hole to be sleeved along and a top surface thereof for resting the CD;
wherein, the sticking seat includes an extension position and a retracting position; while in the retracting position, the top surface of the sticking seat is lower than the supporting surface of the base; and while in the extension position, the top surface is higher than the supporting surface so that the CD rests on the top surface by a predetermined distance from the supporting surface;
wherein, when the sticking seat is in the extension position and the CD is located upon the top surface, the sticking seat will be pushed down to the retracting position if the upper case covers up the lower case closely.

11. The CD labeling device of claim 10, wherein said sticking seat includes thereof a bumpy anchoring portion located on said top surface.

12. The CD labeling device of claim 11, wherein said anchoring portion is choosing from a group consisting of a ring body and a short pillar body.

13. The CD labeling device of claim 10 further includes a cleaning block with a bottom cleaning surface removably mounted inside said upper case.

14. The CD labeling device of claim 10 further includes an openable auxiliary compartment below the lower case for storing cleaning materials.

15. The CD labeling device of claim 10 further includes a driving unit and at least a cleaning means rotationally mounted inside said upper case, the cleaning means having a bottom cleaning surface, and the driving unit for driving the cleaning means further including a shaft to penetrate through said upper case.

16. The CD labeling device of claim 10, wherein said base further includes an elastic means integrally formed thereunder for providing spring force against depression thereon.

17. The CD labeling device of claim 10 further includes a resilient member located between said sticking seat and said base center.

18. A CD cleaning device, comprising:
a basin-shaped upper case for accommodating at least a cleaning means which has a flat bottom cleaning surface for cleaning CDs;
a lower case engageable with the upper case, said lower case having a base which includes a supporting surface to carry a CD and having a base center aligning with CD center; and
an openable auxiliary compartment located below the lower case for storing cleaning materials.

19. The CD cleaning device of claim 19 further includes a driving unit rotationally mounted inside said upper case for driving said cleaning means rotationally mounted inside said upper case, the driving unit for driving the cleaning means further including a shaft to penetrate through said upper case; said base further having an engaging shaft engageable with the driving unit.
